(19) United States
(12) Patent Application Publication
(10) Pub. No.: US 2008/0041462 A1
(43) Pub. Date: Feb. 21, 2008

(54) Fracture treatment check valve

(76) Inventors: Van R. Janway, Ruston, LA (US); Lorne R. Moseley, Haughton, LA (US)

Correspondence Address: John M. Harrison, 2139 E. Bert Kouns, Shreveport, LA, 71105, US

(21) Appl. No.: 11/712,853

(22) Filed: Mar. 1, 2007

Related U.S. Application Data
(60) Provisional application No. 60/838,623, filed on Aug. 21, 2006.

(51) Int. Cl. F16K 15/00

(52) U.S. Cl. 137/515

(57) ABSTRACT

A fracture treatment check valve is disclosed. An illustrative embodiment of the fracture treatment check valve includes a valve housing including a valve housing wall defining a valve housing interior. A valve housing inlet is provided in the valve housing interior. At least one port opening having at least one beveled flow surface extends through the valve housing wall in spaced-apart relationship with respect to the valve housing inlet. A ball seat extends from the valve housing wall into the valve housing interior between the valve housing inlet and the at least one port opening. A valve ball is provided in the valve housing interior and positional between a first position in which the valve ball seats against the ball seat and a second position in which the valve ball disengages the ball seat and establishes fluid communication between the valve housing inlet and the at least one port opening. A valve spring is provided in the valve housing interior and normally biases the valve ball in the first position.

### CROSS-REFERENCES TO RELATED APPLICATIONS

This application claims the benefit of and incorporates by reference U.S. provisional application Ser. No. 60/838,623, filed Aug. 21, 2006.

This invention relates to check valves, and more particularly, to a fracture treatment check valve which is provided on a tubing string in a well bore of a hydrocarbon well to seal the bottom segment of the tubing string while enabling the top segment of the tubing string to be opened for repositioning of the tubing string among multiple fractions in a well casing, for example.

### BACKGROUND

Prior to completion of a hydrocarbon well, porosity and water saturation calculations are used to identify the primary pay intervals or fractions. These primary fractions or intervals are typically then perforated and stimulated by pumping fracturing fluid into the well through a tubing string to fracture hydrocarbon-containing rock or strata in the well formation and ensure optimum flow of hydrocarbons from the well. Commonly, secondary pay intervals or fractions exist between the primary fractions and are often bypassed during production. The secondary fractions are initially not completed due to a number of reasons such as, for example, insufficient porosity or fluid pressure of the fractions or excessive water saturation of the fractions. In some instances, the secondary fractions communicate with other fractions having higher water saturations or lower pressures which hinder the production of hydrocarbons from the fractions.

After the primary fractions are completed and produced to depletion, the secondary or bypassed fractions are typically considered for production. However, since the secondary fractions are often embedded in or near the primary fractions, it is difficult to isolate and stimulate the secondary fractions separately since the tubing string must be opened to reposition the tubing string at each secondary fraction. This opening of the tubing string causes the undesired release of pressure from the well. Therefore, a fracture treatment check valve is needed which is provided on a tubing string in a well bore and facilitates sealing of the bottom segment of the tubing string while enabling the top segment of the tubing string to be opened for repositioning of the tubing string among multiple secondary fractions in an oil well casing, for example, thus preventing the undesired release of pressure from the well.

### SUMMARY

The present invention is generally directed to a fracture treatment check valve. An illustrative embodiment of the fracture treatment check valve includes a valve housing including a valve housing wall defining a valve housing interior. A valve housing inlet is provided in the valve housing interior. At least one port opening having at least one beveled flow surface extends through the valve housing wall in spaced-apart relationship with respect to the valve housing inlet. A ball seat extends from the valve housing wall into the valve housing interior between the valve housing inlet and the at least one port opening. A valve ball is provided in the valve housing interior and positional between a first position in which the valve ball seats against the ball seat and a second position in which the valve ball disengages the ball seat and establishes fluid communication between the valve housing inlet and the at least one port opening. A valve spring is provided in the valve housing interior and normally biases the valve ball in the first position.

### BRIEF DESCRIPTION OF THE DRAWINGS

The invention will now be described, by way of example, with reference to the accompanying drawings, in which:

FIG. 1 is a side view of an illustrative embodiment of the fracture treatment check valve of this invention, provided on a tubing string (partially in section);

FIG. 2 is a longitudinal sectional view, taken along section lines 2-2 in FIG. 1, of the fracture treatment check valve and tubing string section, with a valve ball element illustrated in a sealing position against a ball seat in a valve housing element of the fracture treatment check valve;

FIG. 3 is a longitudinal, exploded sectional view of valve housing and end cap elements of the fracture treatment check valve;

FIG. 4 is an end view of an end cap element of the fracture treatment check valve;

FIG. 5 is a longitudinal sectional view of the fracture treatment check valve, with the valve ball element of the fracture treatment check valve illustrated in an unsealing position;

FIG. 6 is a schematic view of a tubing string, inserted in a well casing of an oil well having multiple primary and secondary fractions, more particularly illustrating stimulation of a first stage bypassed secondary fraction in the well;

FIG. 7 is a schematic view of a tubing string, repositioned in the well casing illustrated in FIG. 6 and more particularly illustrating stimulation of a second stage bypassed secondary fraction in the well; and

FIG. 8 is a schematic view of a tubing string, repositioned in the well casing illustrated in FIGS. 6 and 7 and more particularly illustrating stimulation of a third stage bypassed secondary fraction in the well.

### DETAILED DESCRIPTION

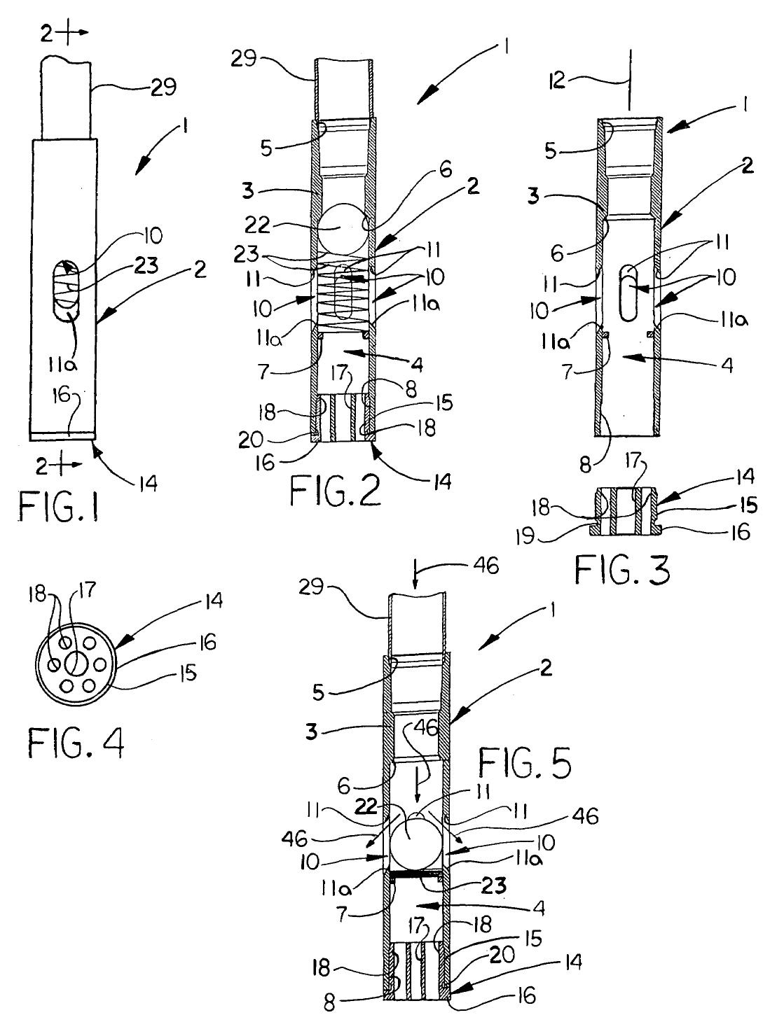

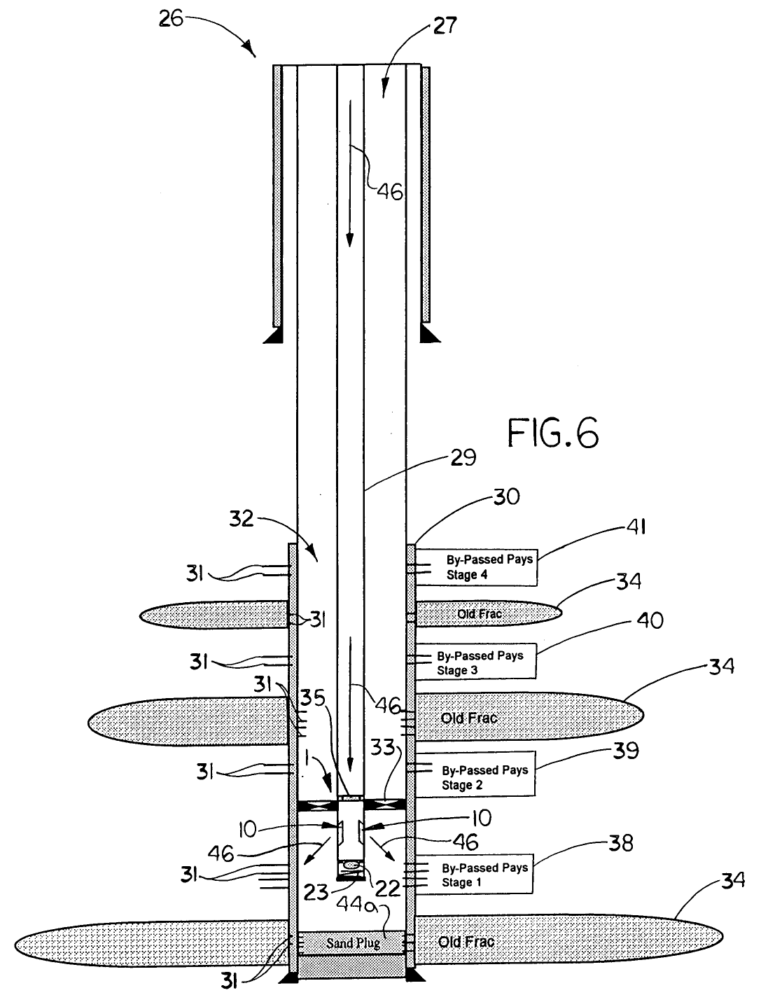

Referring initially to FIGS. 1-5 of the drawings, an illustrative embodiment of the fracture treatment check valve of this invention is generally indicated by reference numeral 1. The fracture treatment check valve 1 includes a valve housing 2 having a valve housing wall 3 which may have a stainless steel construction, for example, and is typically elongated and cylindrical. As illustrated in FIGS. 2, 3 and 5, the valve housing wall 3 defines a valve housing interior 4. The valve housing interior 4 has a valve housing inlet 5 typically at one end and a cap receptacle 8 typically at the opposite end of the valve housing 2. As illustrated in FIGS. 2 and 5, the valve housing inlet 5 of the valve housing interior 4 is adapted to receive a tubing string 29 which may be coupled to the valve housing 2 using any suitable technique known by those skilled in the art, such as using a conventional pup joint 35 (FIG. 6), for example.

At least one port opening 10 extends through the valve housing wall 3, in spaced-apart relationship with respect to the valve housing inlet 5, as illustrated in FIG. 3. Each port opening 10 typically has a generally elongated or elliptical shape, the longitudinal axis of which port opening 10 is disposed in generally parallel relationship with respect to the longitudinal axis 12 of the valve housing 2, as further illustrated in FIG. 3. Typically, four port openings 10 extend through the valve housing wall 3 in spaced-apart relationship with respect to each other around the circumference of the valve housing 2. As illustrated in FIGS. 2, 3 and 5, each port opening 10 has at least one beveled flow surface such as a first beveled flow surface 11 at a first end of the port opening 10 which is nearer the valve housing inlet 5 and a second beveled flow surface 11a at a second end of the port opening 10 which is nearer the cap receptacle 8. Each first beveled flow surface 11 and second beveled flow surface 11a extends through the valve housing wall 3 at an angle with respect to the longitudinal axis 12 (FIG. 3) of the valve housing 2. From the first end of each port opening 10 (which is nearer the valve housing inlet 5) and toward the second end of the port opening 10 (which is nearer the cap receptacle 8), each first beveled flow surface 11 angles outwardly from the valve housing interior 4 and toward the exterior surface of the valve housing wall 3. Each second beveled flow surface 11a is disposed in generally parallel relationship with respect to the first beveled flow surface 11 of the corresponding port opening 10.

An annular ball seat 6 extends from the valve housing wall 3 and into the valve housing interior 4 between the valve housing inlet 5 and the at least one port opening 10. The ball seat 6 is typically disposed in generally adjacent, spaced-apart relationship with respect to the valve housing inlet 5. As illustrated in FIG. 3, the ball seat 6 typically has a generally beveled cross-sectional shape and, is angled toward the center of the valve housing interior 4. The ball seat 6 generally faces the cap receptacle 8 end of the valve housing 2.

A spring seat 7 extends from the valve housing wall 3 and into the valve housing interior 4, between the port openings 10 and the cap receptacle 8. The spring seat 7 is typically adjacent to the second beveled flow surface 11a of each port opening 10. The spring seat 7 may have a continuous, annular configuration, or alternatively, may be discontinuous and multi-segmented.

An end cap 14 is provided in the cap receptacle 8 of the valve housing 2. The end cap 14 has a cap body 15 which typically has a generally cylindrical shape. As illustrated in FIG. 3, a circumferential cap flange 16 may extend from the cap body 15. At least one opening extends through the cap body 15. The at least one opening may include, for example, a central cap opening 17 which extends through the central portion of the cap body 15. Multiple peripheral cap openings 18 may additionally extend through the cap body 15, typically in surrounding relationship with respect to the central cap opening 17, as illustrated in FIG. 4. As illustrated in FIGS. 2 and 5, the cap body 15 of the end cap 14 is inserted in the cap receptacle 8 of the valve housing interior 4 until the cap flange 16 engages the end of the valve housing 2. The cap body 15 may engage the interior surfaces of the cap receptacle 8 in a friction fit, or alternatively, may be attached to the valve housing 2 using any suitable technique which is known by those skilled in the art, such as through welding, for example. Still further in the alternative, the cap body 15 may detachably engage the interior surfaces of the cap receptacle 8 such as through cap threads (not illustrated) which are provided on the cap body 15 and engage complementary receptacle threads (not illustrated) provided on the interior surfaces of the cap receptacle 8. Accordingly, the valve housing interior 4 can be accessed, as deemed necessary, by removing the end cap 14 from the valve housing 2. As illustrated in FIG. 3, an annular o-ring groove 19 may be provided in the exterior surface of the cap body 15, typically adjacent to the cap flange 16 to accommodate an o-ring 20, as illustrated in FIGS. 2 and 5. The o-ring 20 provides a fluid-tight seal between the cap body 15 of the end cap 14 and the interior surfaces of the cap receptacle 8. In typical application of the fracture treatment check valve 1, which will be hereinafter described, the central cap opening 17 and peripheral cap openings 18 in the cap body 15 of the end cap 14 facilitate the flow of air between the valve housing interior 4 and the exterior of the valve housing 2.

As further illustrated in FIGS. 2 and 5, a valve ball 22, which typically has a stainless steel construction, is provided in the valve housing interior 4 between the ball seat 6 and the spring seat 7. A coiled valve spring 23 provided in the valve interior 4 is seated against the spring seat 7 and engages the valve ball 22. As illustrated in FIG. 2, the valve spring 23 normally biases the valve ball 22 against the ball seat 6, thereby providing a fluid-tight seal between the valve housing inlet 5 and the port openings 10 of the valve housing 2. Therefore, the valve ball 22 normally prevents flow of fluid or discharge of pressure from outside the valve housing 2 through the port openings 10 and/or end cap 14, into the valve housing interior 4 and then through the valve housing inlet 5 of the valve housing 2. As illustrated in FIG. 5, responsive to the introduction of a hydraulic fracturing fluid 46 into the valve housing interior 4 at the valve housing inlet 5, as will be hereinafter described, the fracturing fluid 46 impinges against the valve ball 22, unseating the valve ball 22 from the ball seat 6 such that the valve ball 22 compresses the valve spring 23 against the spring seat 7. Accordingly, the valve ball 22 clears the port openings 10, establishing fluid communication between the valve housing inlet 5 and the port openings 10 to facilitate flow of the fracturing fluid 46 from the valve housing interior 4 through the port openings 10. Moreover, as further illustrated in FIG. 5, the first beveled flow surface 11 and second beveled flow surface 11a of each port opening 10 direct the fracturing fluid 46 outwardly at an angle with respect to the longitudinal axis 12 (FIG. 3) of the valve housing 2.

Referring next to FIGS. 6-8 of the drawings, a hydrocarbon well 26 in typical application of the fracture treatment check valve 1 of this invention is illustrated. The hydrocarbon well 26 includes a subterranean well bore 27 at least a portion of which is lined by a well casing 3.0. The well casing 30 is surrounded by a subterranean formation (not illustrated) which contains hydrocarbons. At various stages of hydrocarbon production, perforations 31 are extended through the well casing 30 to facilitate the extraction of hydrocarbons from the formation at different primary fractions 34 which are located at vertically-spaced levels in the formation. During completion of the hydrocarbon well 26, tubing strings 29 are sequentially inserted into the well bore 27, one of which is used to inject the hydraulic fracturing fluid 46 into the formation to stimulate the flow of hydrocarbons from the formation and into the well bore 27 through the perforations 31 and another of which is used as a production string to extract the hydrocarbons from the well bore 27 to the ground surface. A packer 33 is typically inserted in the well bore 27 between the well casing 30 and the tubing string 29, at a level which is above the primary fraction 34 undergoing stimulation or production. The packer 33 maintains the tubing string 29 in a central location in the well bore 27 and maintains downhole pressure in the well bore 27 beneath the packer 33. An annulus 32 is defined between the well casing 30 and the centralized tubing string 29.

Various surface components (not illustrated) which are typically located at or above ground level during stimulation and/or production of hydrocarbons from the hydrocarbon well 26 typically include an annulus pump (not illustrated) which applies down pressure against the packer 33 through the annulus 32; a blowout preventer (BOP) (not illustrated) which is provided at the upper end of the tubing string 29 to prevent excessive downhole pressure from escaping the well bore 27 through the tubing string 29 and causing a blowout; a block valve (not illustrated) which is provided on the open end of the tubing string 29 and facilitates the unidirectional flow of fracturing fluid 46 through the tubing string 29; and a workover rig (not illustrated) which supports the above-ground production equipment.

The primary fractions 34 are initially stimulated for hydrocarbon production typically by pumping a fracturing fluid 46 (FIG. 6) through a tubing string 29 and into the well bore 27. During subsequent production of hydrocarbons from the hydrocarbon well 26, the multiple primary fractions 34 are produced typically to depletion. For purposes of illustration herein, a first stage bypassed secondary fraction 38; a second stage bypassed secondary fraction 39; a third stage bypassed secondary fraction 40; and a fourth stage bypassed secondary fraction 41 remain in the formation after production of the primary fractions 34. During production of the primary fractions 34, the bypassed fractions 38-41 are bypassed for production due to any of various conditions which hinder production of hydrocarbons from the bypassed fractions 38-41. However, since at least some quantity of hydrocarbons can potentially be produced from the bypassed fractions 38-41, it is desirable to individually isolate these bypassed fractions 38-41 and stimulate them for production after production of the primary fractions 34.

Referring again to FIGS. 5-8 of the drawings, in typical application of the fracture treatment check valve 1, the bypassed fractions 38-41 which remain in the hydrocarbon formation after production of hydrocarbons from the primary fractions 34 are initially identified typically using open-hole log information or other geological techniques known by those skilled in the art. Perforations 31 are then extended through the well casing 30 at each of the bypassed fractions 38-41. A plug such as a first sand plug 44a or a wireless bridge plug (not illustrated), for example, is then provided in the well bore 27 beneath the first stage bypassed secondary fraction 38 in the well bore 27 to isolate the first stage bypassed secondary fraction 38 from the bottommost primary fraction 34. In the example illustrated in FIG. 6, a first sand plug 44a isolates the perforations 31 of the bottommost primary fraction 34 from the perforations 31 of the first stage bypassed secondary fraction 38.

The fracture treatment check valve 1 is connected to the discharge end of the tubing string 29, typically using a pup joint 35. Next, the packer 33 is placed in the well bore 27, after which the fracture treatment check valve 1 and tubing string 29 are lowered into the well bore 27 and extended through the packer 33. Accordingly, the packer 33 centralizes the tubing string 29 in the well bore 27 and isolates the first stage bypassed secondary fraction 38 from each of the primary fractions 34 and the second stage bypassed secondary fraction 39, third stage bypassed secondary fraction 40 and fourth stage bypassed secondary fraction 41 located above the packer 33. As illustrated in FIG. 6, the packer 33 is set typically at about 20 feet above the perforations 31 of the first stage bypassed secondary fraction 38.

As illustrated in FIGS. 5 and 6, after the packer 33 and tubing string 29 are positioned in the well bore 27, fracturing fluid 46 is pumped downwardly through the tubing string 29 and into the valve housing interior 4 (FIG. 5) in the valve housing 2 of the fracture treatment check valve 1 through the valve housing inlet 5. As it flows from the valve housing inlet 5 toward the port openings 10 in the valve housing 2, the fracturing fluid 46 impinges against the valve ball 22, unseating the valve ball 22 from the ball seat 6 and compressing the valve spring 23 between the valve ball 22 and the spring seat 7, as further illustrated in FIG. 5. Therefore, the valve ball 22 is forced beyond the first beveled flow surfaces 11 of the respective port openings 10, thereby establishing fluid communication between the valve housing inlet 5 of the valve housing interior 4 and the port openings 10. The central cap opening 17 (FIG. 2) and/or peripheral cap openings 18 in the end cap 14 facilitate the escape of air from the valve housing interior 4 during displacement of the valve ball 22. Accordingly, the fracturing fluid 46 flows under pressure from the valve housing inlet 5 and beyond the ball seat 6 and unseated valve ball 22, respectively, and is discharged from the valve housing interior 4 through the port openings 10. As illustrated in FIGS. 5 and 6, the first beveled flow surface 11 and the second beveled flow surface 11a of each port opening 10 direct the fracturing fluid 46 downwardly and outwardly at an angle with respect to the longitudinal axis 12 (FIG. 3) of the valve housing 2. Therefore, the fracturing fluid 46 flows directly toward and then through the perforations 31 in the well casing 30, into the formation (not illustrated) surrounding the well casing 30 at the level of the first stage bypassed secondary fraction 38. In the formation, the fracturing fluid 46 cracks and fractures strata or rock (not illustrated) which contains the hydrocarbons. Proppant (not illustrated) may be placed in the fracture to prevent the fracture from closing, and thus, improve flow of the recoverable hydrocarbon from the formation, as is known by those skilled in the art. As the fracturing fluid 46 is pumped through the tubing string 29, the annulus pump (not illustrated) applies down pressure against the packer 33 through the annulus 32.

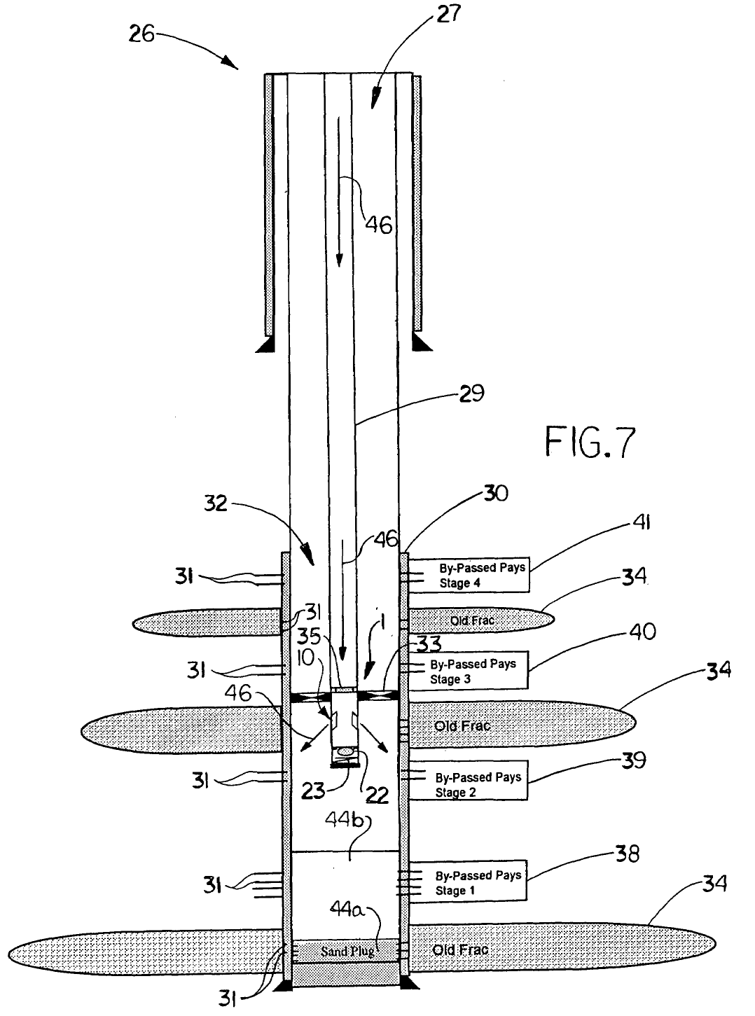

As illustrated in FIG. 7, after stimulation of the first stage bypassed secondary fraction 38, typically as was heretofore described, a second sand plug 44b is formed in the well bore 27 to cover the perforations 31 of the first stage bypassed secondary fraction 38, typically by pumping sand slurry (not illustrated) into the well bore 27 through the tubing string 29. During formation of the second sand plug 44b, the annulus pump (not illustrated) typically increases down pressure against the packer 33 through the annulus 32 to reduce the resulting pressure differential across the packer 33. The block valve (not illustrated) is then removed from the above-ground segment (not illustrated) of the tubing string 29, after which the packer 33 is released from the interior surfaces of the well casing 30. The tubing string 29 is then unthreaded from the rig floor (not illustrated) of the workover rig (not illustrated) and the tubing string 29 re-positioned for stimulation of the second stage bypassed secondary fraction 39, as illustrated in FIG. 7. The packer 33 is placed typically about 20 feet above the second stage bypassed secondary fraction 39, and the annulus pump (not illustrated) reduces down pressure against the packer 33 to typically about 1000 psi. Any sand slurry (not illustrated) which remains in the tubing string 29 is typically discharged onto the second sand plug 44b.

Removal of the block valve (not illustrated) from the above-ground segment (not illustrated) of the tubing string 29 in order to reposition the tubing string 29 and packer 33 in the well bore 27, as was noted hereinabove, opens the upper end (not illustrated) of the tubing string 29. Referring to FIG. 2 of the drawings, it will be appreciated by those skilled in the art that the fracture treatment check valve 1 prevents the escape of downhole pressure from the well bore 27 through the tubing string 29 upon removal of the block valve from the tubing string 29. As illustrated in FIG. 2, when flow of the fracturing fluid 46 through the tubing string 29 ceases, the valve spring 23 biases the valve ball 22 against the ball seat 6 in the valve housing interior 4 of the valve housing 2 due to the reduced pressure in the tubing string 29. The fluid-tight seal between the valve ball 22 and the ball seat 6 prevents downhole pressure from entering the valve housing inlet 5 portion of the valve housing 2 through the port openings 10 and the central cap opening 17 and/or peripheral cap openings 18 in the end cap 14 of the fracture treatment check valve 1.

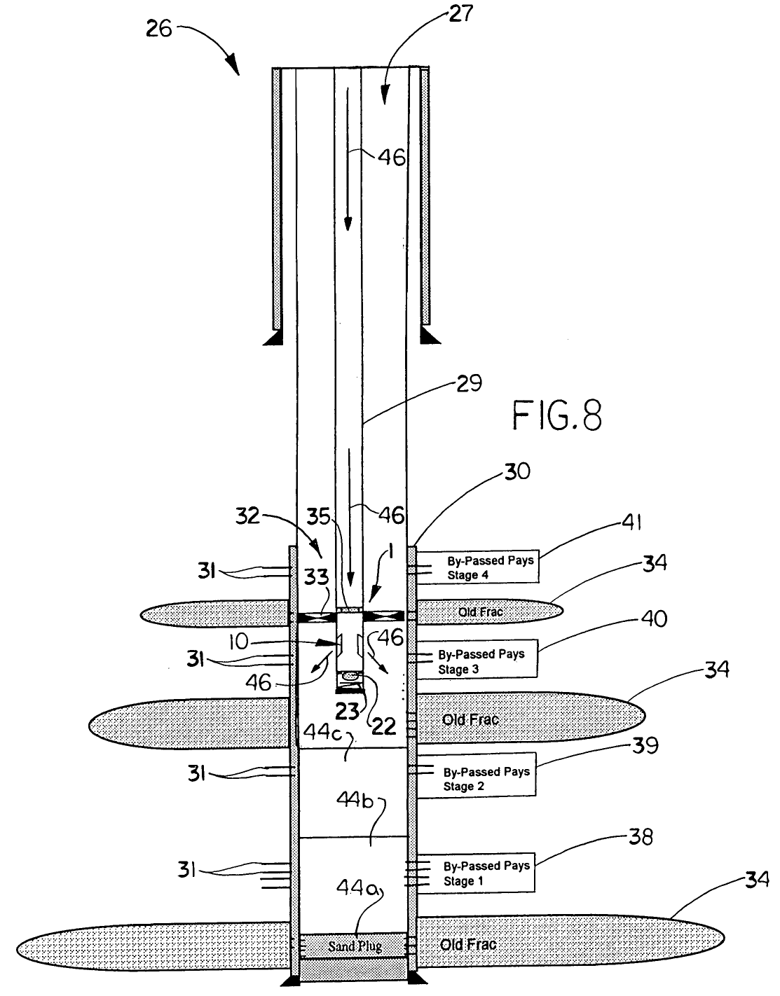

After stimulation of the first stage bypassed secondary fraction 38 as was heretofore described with respect to FIG. 6, the same procedure is typically repeated to stimulate the second stage bypassed secondary fraction 39 for hydrocarbon production, as illustrated in FIG. 7. After stimulation of the second stage bypassed secondary fraction 39 is completed, a third sand plug 44c is typically formed above the second sand plug 44b in the well bore 27, as illustrated in FIG. 8, to isolate the third stage bypassed secondary fraction 40 from the second stage bypassed secondary fraction 39. As further illustrated in FIG. 8, the tubing string 29 and packer 33 are then repositioned in the well bore 27 and the third stage bypassed secondary fraction 40 is stimulated for hydrocarbon production typically in the same manner as was heretofore described in FIG. 6 with respect to stimulation of the first stage bypassed secondary fraction 38. The fourth stage bypassed secondary fraction 41 is then stimulated for hydrocarbon production typically in a similar manner. After each repositioning of the tubing string 29 and packer 33 between the bypassed fractions 38-41, the fracture treatment check valve 1 prevents escape of downhole pressure through the tubing string 29 which is necessitated by removal of the block valve (not illustrated) from the upper segment (not illustrated) of the tubing string 29.

After stimulation of the fourth stage bypassed secondary fraction 41 is completed, the packer 33 and tubing string 29 with fracture treatment check valve 1 are removed from the well bore 27. Coiled tubing (not illustrated) is then extended into the well bore 27 and the sand plugs 44a-44c are washed out to the desired depth in the well bore 27. The coiled tubing is then removed from the well bore 27, after which production tubing (not illustrated) is extended into the well bore 27, followed by completion of the hydrocarbon well 26. After flow testing of the hydrocarbon well 26, hydrocarbons are produced from the first stage bypassed secondary fraction 38, second stage bypassed secondary fraction 39, third stage bypassed secondary fraction 40 and fourth stage bypassed secondary fraction 41 and through the production tubing (not illustrated).

While the preferred embodiments of the invention have been described above, it will be recognized and understood that various modifications can be made in the invention and the appended claims are intended to cover all such modifications which may fall within the spirit and scope of the invention.

Having described my invention with the particularity set forth above, I claim:

1. A fracture treatment check valve comprising:
a valve housing including a valve housing wall defining a valve housing interior;
a valve housing inlet provided in said valve housing interior;
at least one port opening having at least one beveled flow surface extending through said valve housing wall in spaced-apart relationship with respect to said valve housing inlet;
a ball seat extending from said valve housing wall into said valve housing interior between said valve housing inlet and said at least one port opening;
a valve ball provided in said valve housing interior, said valve ball positional between a first position wherein said valve ball seats against said ball seat and a second position wherein said valve ball disengages said ball seat and establishes fluid communication between said valve housing inlet and said at least one port opening; and
a valve spring provided in said valve housing interior and normally biasing said valve ball in said first position.

2. The fracture treatment check valve of claim 1 further comprising an end cap having at least one cap opening carried by said valve housing in spaced-apart relationship with respect to said valve spring.

3. The fracture treatment check valve of claim 2 wherein said end cap comprises a cap body carried by said valve housing and wherein said at least one cap opening comprises a central cap opening and a plurality of peripheral cap openings extending through said end cap.

4. The fracture treatment check valve of claim 2 further comprising a cap receptacle provided in said valve housing interior in spaced-apart relationship with respect to said valve spring and wherein said end cap is inserted in said cap receptacle.

5. The fracture treatment check valve of claim 1 wherein said at least one beveled flow surface comprises a pair of generally parallel beveled flow surfaces extending through said valve housing wall in spaced-apart relationship with respect to each other.
